(19) United States
(12) Patent Application Publication
(10) Pub. No.: US 2007/0132190 A1
(43) Pub. Date: Jun. 14, 2007

(54) Axial dynamic brush seal

(76) Inventor: Charles Trabert, Warwick, RI (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/301,228

(22) Filed: Dec. 12, 2005

(51) Int. Cl. F16J 15/44

(52) U.S. Cl. 277/355

(57) ABSTRACT

An axial and dynamic brush seal system wherein a mating ring is attached to a rotor and has a sealing surface. The bristles of the brush seal are disposed about the rotor and extend axially so that the terminal free ends of the bristles engage the sealing surface of the mating ring.

### FIELD OF THE INVENTION

This subject invention relates to brush seals and in particular a new axial, dynamic brush seal and brush seal system.

### BACKGROUND OF THE INVENTION

Brush seals are well known. See U.S. Pat. No. 6,231,047 incorporated herein by this reference. Typically, the bristles of the brush seal are disposed between a front plate and a back plate surrounding a rotating shaft. The free ends of the bristles engage the shaft sealing it with respect to a housing. Most prior art brush seals are thus radial in design in that the bristles extend radially towards the rotating shaft.

U.S. Pat. No. 5,480,162, also incorporated herein by this reference, proposes an axial brush seal for sealing a combustor assembly with respect to an adjoining stator assembly in a gas turbine engine. The stator assembly does not move but the combustor assembly does move towards and away from the stator assembly. The brushseal bristles provide a seal between the combustor assembly and the stator assembly and the back plate of the brush seal is designed to bear against the stator assembly to transmit axial loads. See also U.S. Pat. Nos. 6,170,831 and 5,114,159 also incorporated herein by this reference. U.S. pending Patent Application Nos. U.S. 2005/0110218 and U.S. 2003/0131602, also incorporated herein by this reference, propose axial brush seal arrangements which are floating but require complex housing arrangements and have no provisions for pressure induced blow-down of the bristles against the mating ring or runner.

To our knowledge, the prior art does not disclose a flexible axial brush seal which can be easily implemented into a sealing system used dynamically to seal a rotor such as a rotating shaft with respect to a housing through which the rotor extends.

### SUMMARY OF THE INVENTION

It is therefore an object of this invention to provide an axial brush seal for sealing a rotor such as a rotating shaft and useful in turbine engines, steam turbines, compressors, blowers, fans, mixers, turbocharges, and other rotating hardware such as spindles.

It is a further object of this invention to provide such an axial, dynamic brush seal which is easy and economical to manufacture.

The subject invention results from the realization that if a brush strip element of a radial brush seal is bent 90° out of plane, it can now be used as an axial, dynamic seal and manufactured easily and economically.

The subject invention, however, in other embodiments, need not achieve all these objectives and the claims hereof should not be limited to structures or methods capable of achieving these objectives.

This subject invention features an axial and dynamic brush seal system. A mating ring is attached to a rotor and has a sealing surface. A plurality of bristles are disposed about the rotor and extend axially so the terminal free ends of the bristles engage the sealing surface of the mating ring. In one example, the rotor extends along a longitudinal axis and the sealing surface of the mating ring is angled with respect to an axis perpendicular to the longitudinal axis. The sealing surface can be angled away from the bristles or towards the bristles. In another example, the bristles are angled with respect to the sealing surface of the mating ring. The sealing surface of the mating ring can be angled to match the terminal free ends of the bristles in a blow down condition.

There is typically a housing for the bristles. In one example, the housing includes an axially extending front plate and an axially extending back plate about the bristles. Further included may be a retainer for the bristles sandwiched between the front and back plates.

In one example, the housing includes a subsystem configured to urge the free ends of the bristles against the sealing surface of the mating ring. For example, the housing may include a first magnet and a second magnet is associated with the bristles to urge the free ends of the bristles against the sealing surface of the mating ring.

An axially extending dynamic brush seal in accordance with the subject invention features a plurality of bristles configured to be disposed about a rotor. The terminal ends of the bristles are designed to engage a sealing surface attached to the rotor. There is also a housing for holding the bristles.

### BRIEF DESCRIPTION OF THE DRAWINGS

Other objects, features and advantages will occur to those skilled in the art from the following description of a preferred embodiment and the accompanying drawings, in which:

FIG. 1 is a schematic cross-sectional view of a typical prior art radial brush seal;

FIG. 2 is a schematic side cross-sectional view showing one embodiment of a brush seal assembly in accordance with the subject invention;

FIG. 3 is a schematic cross-sectional side view showing another embodiment of a brush seal assembly in accordance with the subject invention;

FIG. 4 is a schematic cross-sectional side view showing still another embodiment of a brush seal assembly in accordance with the subject invention;

FIG. 5 is a schematic cross-sectional side view showing still another embodiment of a brush seal assembly in accordance with the subject invention;

FIG. 6 is a schematic cross-sectional side view showing still another embodiment of a brush seal assembly in accordance with the subject invention;

FIG. 7 is a schematic cross-sectional side view showing still another embodiment of a brush seal assembly in accordance with the subject invention; and

FIG. 8 is a schematic cross-sectional side view showing an embodiment of a brush seal assembly in accordance with the subject invention including a subsystem for urging the free ends of the bristles against the mating ring.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

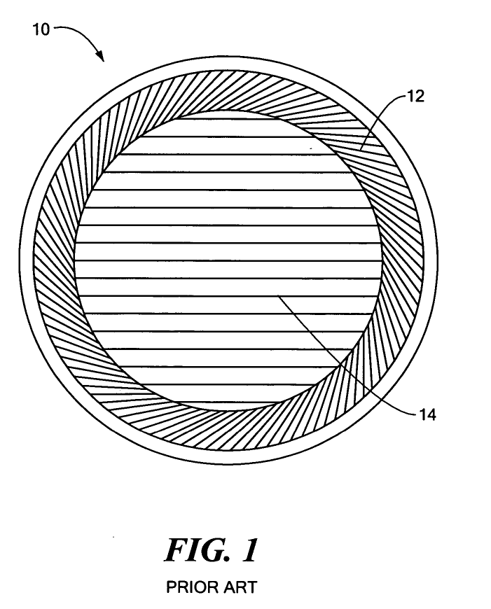

In a typical radial brush seal installation, brush seal 10, FIG. 1 is arranged such that bristles 12 surround shaft 14, extend towards the shaft, and the free end of the bristles engage the shaft as shown in FIG. 1.

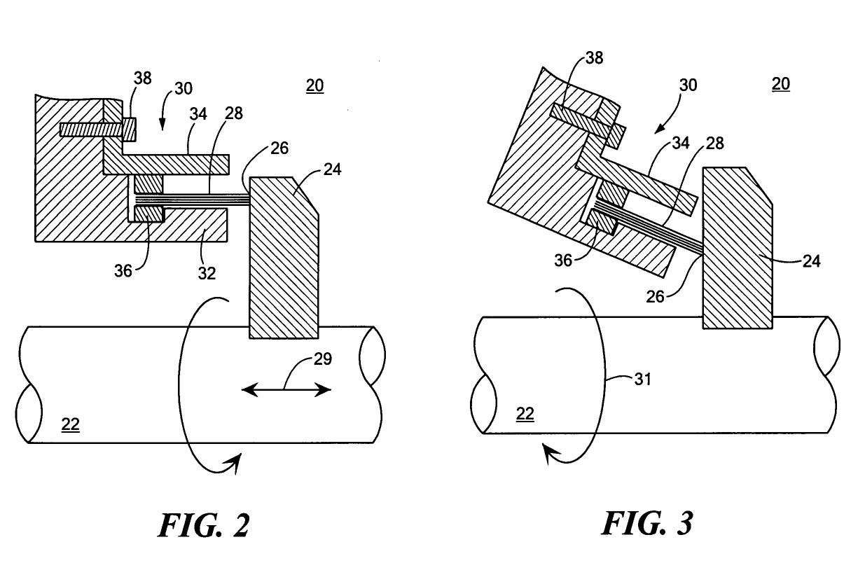

Axial brush seal system 20, FIG. 2 in accordance with this subject invention, in contrast, includes rotor 22, typically a rotating shaft, and mating ring 24 attached to rotor 22 to rotate with it. Mating ring 24 includes or defines sealing surface 26.

Bristles 28 of axially disposed brush seal 30 are disposed about rotor 22 and extend axially in the same direction as the longitudinal axis of rotor 22 such that the terminal free ends of bristles 28 engage sealing surface 26 of mating ring 24. Bristles 28 provide for adequate sealing even when mating ring 24 and rotor 22 move in the axial direction shown by arrow 29 and/or in a direction transverse to arrow 29.

One example of a brush seal in accordance with the subject invention includes a stationary housing fixed to a non-rotating component of the structure (not shown) through which rotor 22 extends. The brush seal housing includes front plate 34 and back plate 32 with retainer 36 sandwiched therebetween to hold the non-free ends of the bristles. See U.S. Pat. No. 6,231,047. Fastener 38 secures back plate 34 to front plate 32. In other embodiments, however, the back plate and the front plate may be welded or otherwise fixed to each other. Neither the front nor the back plates contact sealing surface 26. Other designs for the housing of the bristles of the brush seal are known to those skilled in the art. This brush seal element does not require complex front plate or back plate components but rather a groove in the supporting housing with a simple retainer. The axial brush seal of the subject invention maintains a seal through large axial excursions. The flexible brush strip of U.S. Pat. No. 6,231,047 requires only minimal required radial height to implement the brush seal element.

In another embodiment, bristles 28, FIG. 3 are angled with respect to sealing surface 26 to take advantage of the bristle spread caused by the rotation of rotor 22 in the direction shown in FIG. 3 by arrow 31.

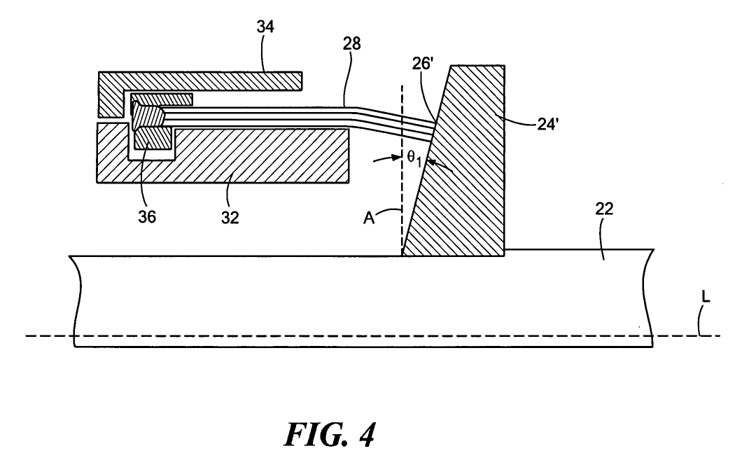

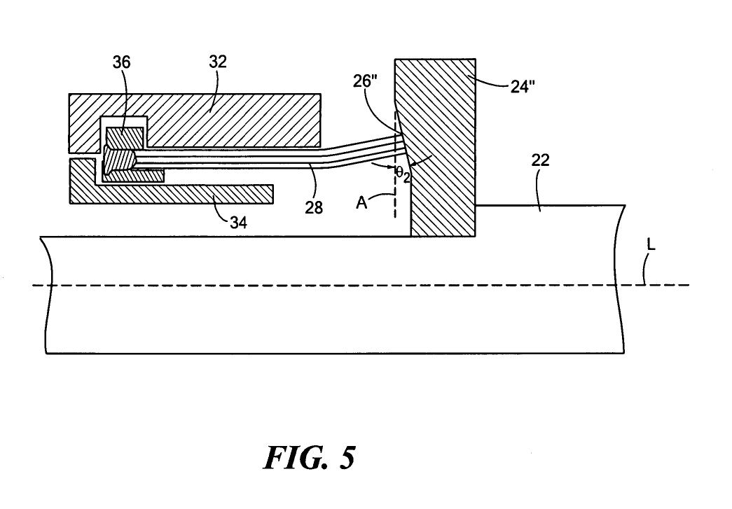

In still another example, the sealing surface is angled with respect to an axis A perpendicular to the longitudinal axis L of rotor 22 as shown in FIGS. 4 and 5. Such a design assists in sealing and the slant angle of the sealing surface better tolerates axial travel. In the example of FIG. 4, sealing surface 26′ of mating ring 24′ is angled at an angle E₁ away from bristles 28 in the case where the higher pressure is located at the outside of the bristles. This design is particularly useful for 0 layer angle. Since the bristles in a 0 layer angle brush seal are parallel to the shaft centerline, the pack is much stiffer and provides high resistance to axial travel. Thus, placing an angle on the mating ring helps the seal during axial travel by allowing the bristles to displace in a radial motion while still providing a seal against the tapered surface. In the example of FIG. 5, sealing surface 26″ of mating ring 24″ is angled at an angle η₂ towards bristles 28 in the case where the higher pressure is located at the inside of the bristles. θ₁ may be between 0° and 45°; θ₂ may be between 0° and 45°.

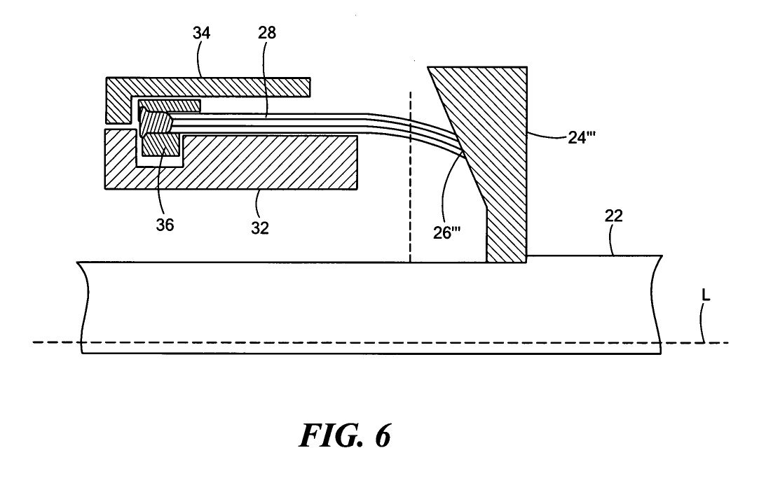

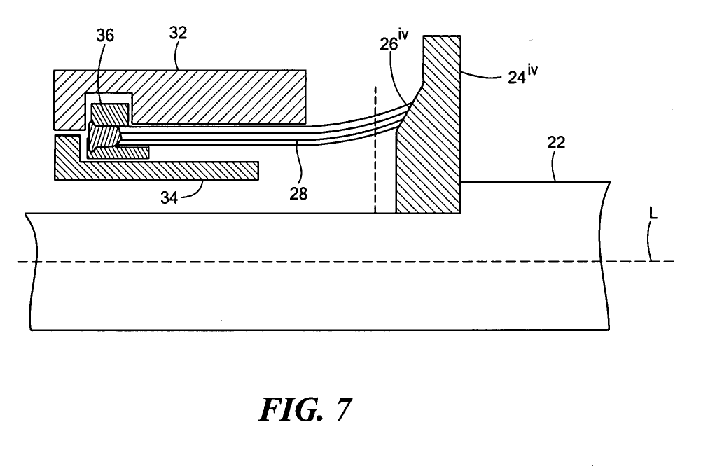

In another embodiment, bristles 28, FIGS. 6 and 7 are angled with respect to the sealing surface during high-pressure induced blow-down where the bristles adjoining back plate 32 attempt to straighten out. This condition produces a tapered shape on the free ends of the bristles as shown. By matching the sealing surfaces 26′″ and 26′^{V} angles to the bristle blow-down condition, the seal will essentially run in a line-to-line state with the rotating surface during operation.

In any embodiment and in any implementation, such an axial, dynamic brush seal is fairly simple to manufacture and readily accommodates movement of the shaft. The brush strip element of the radial brush seal disclosed in U.S. Pat. No. 6,231,047 can be bent 90° out of plane so it can now be used in an axial seal implementation and manufactured easily and economically. The brush seal flexible element, due to its small size, can be easily integrated into the supporting housing with the addition of a groove cut into the housing and a simple retaining feature. The brush seal flexible element is also light weight and therefore can be made to track the sealing surface by use of permanent magnets to create a closing force.

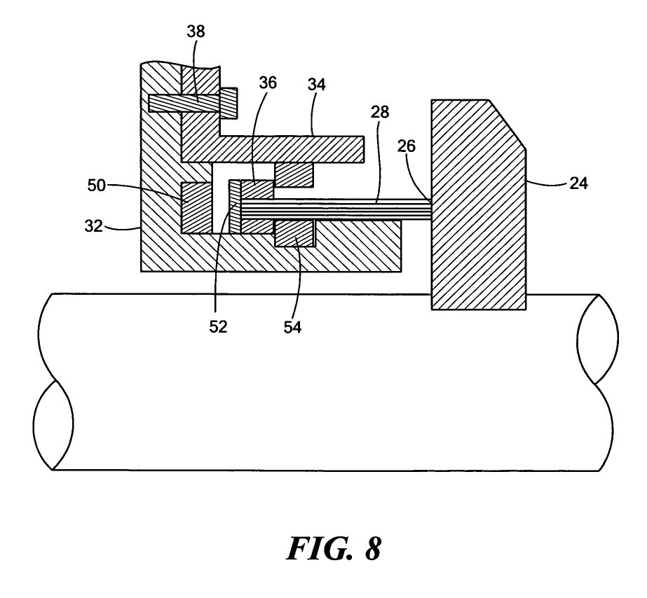

In the embodiment of FIG. 8, for example, back plate 32 includes permanent magnet insert 50 and brush seal retainer 36 includes permanent magnet 52 of the same polarity as permanent magnet 50 to urge retainer 36 and thus the free ends of bristles 28 against sealing surface 26 of mating ring 24. Other subsystems configured to urge the free ends of bristles 28 against the sealing surface 26 of mating ring 24 may also be employed including the combination of magnets 54 and 52.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An axial and dynamic brush seal system comprising:
a rotor;
a mating ring attached to the rotor and having a sealing surface; and
a plurality of bristles about the rotor and extending axially, the terminal free ends of the bristles engaging the sealing surface of the mating ring.

2. The brush seal system of claim 1 in which the rotor extends along a longitudinal axis and the sealing surface of the mating ring is angled with respect to an axis perpendicular to the longitudinal axis.

3. The brush seal system of claim 2 in which the sealing surface is angled away from the bristles.

4. The brush seal system of claim 2 in which the sealing surface is angled towards the bristles.

5. The brush seal system of claim 2 in which the sealing surface of the mating ring is angled to match the terminal free ends of the bristles in a blow down condition.

6. The brush seal system of claim 1 further including a housing for the bristles.

7. The brush seal system of claim 6 in which the housing includes an axially extending front plate and an axially extending back plate about the bristles.

8. The brush seal system of claim 7 further including a retainer for the bristles sandwiched between the front and back plates.

9. The brush seal system of claim 6 in which the housing includes a subsystem configured to urge the free ends of the bristles against the sealing surface of the mating ring.

10. The brush seal system of claim 9 in which the subsystem is magnetic.

11. The brush seal system of claim 10 in which the housing includes a first magnet and there is a second magnet associated with the bristles to urge the free ends of the bristles against the sealing surface of the mating ring.

12. The brush seal system of claim 1 in which the bristles are angled with respect to the sealing surface.

13. An axial and dynamic brush seal system comprising:
a rotor;
a mating ring attached to the rotor and having a sealing surface; and
a stationary housing including a plurality of bristles extending therefrom disposed about the rotor, the bristles extending axially and the terminal free ends of the bristles engaging the sealing surface of the mating ring.

14. The brush seal system of claim 13 in which the rotor extends along a longitudinal axis and the sealing surface of the mating ring is angled with respect to an axis perpendicular to the longitudinal axis.

15. The brush seal system of claim 14 in which the sealing surface is angled away from the bristles.

16. The brush seal system of claim 14 in which the sealing surface is angled towards the bristles.

17. The brush seal system of claim 13 in which the sealing surface of the mating ring is angled to match the terminal free ends of the bristles in a blow down condition.

18. The brush seal system of claim 13 in which the housing includes an axially extending front plate and an axially extending back plate about the bristles.

19. The brush seal system of claim 18 further including a retainer for the bristles sandwiched between the front and back plates.

20. The brush seal system of claim 13 in which the housing includes a subsystem configured to urge the free ends of the bristles against the sealing surface of the mating ring.

21. The brush seal system of claim 20 in which the subsystem is magnetic.

22. The brush seal system of claim 21 in which the housing includes a first magnet and there is a second magnet associated with the bristles to urge the free ends of the bristles against the sealing surface of the mating ring.

23. The brush seal system of claim 9 in which the bristles are angled with respect to the sealing surface.

24. An axially extending dynamic brush seal comprising:
a plurality of bristles configured to be disposed about a rotor wherein the terminal ends of the bristles engage a sealing surface attached to the rotor; and
a housing for holding the bristles.

25. The brush seal system of claim 24 in which the housing includes an axially extending front plate and an axially extending back plate about the bristles.

26. The brush seal system of claim 25 further including a retainer for the bristles sandwiched between the front and back plates.

27. The brush seal system of claim 24 in which the housing includes a subsystem configured to urge the free ends of the bristles against the sealing surface of the mating ring.

28. The brush seal system of claim 27 in which the subsystem is magnetic.

29. The brush seal system of claim 28 in which the housing includes a first magnet and there is a second magnet associated with the bristles to urge the free ends of the bristles against the sealing surface of the mating ring.

30. An axial and dynamic brush seal for a system including a mating ring attached to a rotor and defining a sealing surface, the brush seal comprising:
a plurality of bristles to be disposed about the rotor, the bristles extending axially to engage the sealing surface of the mating ring.
